(19) United States
(12) Patent Application Publication
(10) Pub. No.: US 2009/0019084 A1
(43) Pub. Date: Jan. 15, 2009

(54) METHOD AND SYSTEM FOR PRELOADING

(75) Inventors: Peter Matthew Crandall, Victoria (AU); Glenn Ashley Mitchell, Victoria (AU)

Correspondence Address: CHRISTIE, PARKER & HALE, LLP, PO BOX 7068, PASADENA, CA, 91109-7068, US

(73) Assignee: T. RAD CO., LTD., SHIBUYA-KU TOKYO JAPAN (JP)

(21) Appl. No.: 11/664,631

(22) PCT Filed: Oct. 4, 2005
(86) PCT No.: PCT/AU05/01513

§ 371 Date: Mar. 6, 2008

(30) Foreign Application Priority Data
Oct. 4, 2004 (AU) 2204905723

(51) Int. Cl. G06F 17/00

(52) U.S. Cl. 707/104.1; 707/E17.009

(57) ABSTRACT

The invention relates to integrating a first multimedia work and a second multimedia work to produce a combined multimedia work. The first and/or second multimedia works are converted into a common format such as SWF format, and the first multimedia work is converted to a sub-movie. The converted first multimedia work is inserted into the second multimedia work as a sub-movie of the second multimedia work to produce a combined multimedia work. Instructions in the combined multimedia work are updated in order to maintain the function of those instructions following the combination of the two works.

### CROSS-REFERENCE TO RELATED APPLICATIONS

The present application claims priority from Australian Provisional Patent Application No 2004905723 filed on 4 Oct. 2004, the content of which is incorporated herein by reference.

### FIELD OF THE INVENTION

The present invention relates to the field of multimedia works, and more specifically to a method and apparatus for improving the introduction of multimedia segments into an existing multimedia work.

### BACKGROUND TO THE INVENTION

Multimedia works (or “movies”) are works containing one or more “media” such as text, sound, video, still and animated graphics and the like. Multimedia works may be delivered to a viewer or end-user in a variety of forms, such as live presentations, television broadcasts, computer programs, and Internet web pages. The present invention involves multimedia works that are presented to a user by a display device such as a computer, a mobile phone, or a similar appliance.

The content of a multimedia work can be thought of as a series of individual segments, each having a beginning point and an end point. The individual segments are linked together sequentially in an order determined by the user or other process defined by the author of the multimedia work. Once started, a segment normally executes from its beginning to its end. At the end of a segment a succeeding segment may be selected, according to user input or other variable, from among a generally finite number of alternatives. The identity and number of segments available at each segment end point are set by the author of the multimedia work.

Each segment includes one or more media elements. For example, a segment may include an introductory graphic animation sequence with an accompanying audio track, followed by a video clip, followed by a screen of text. To present (or “play”) a segment, the playback device being used must have available the appropriate resources in the form of the data to be presented and an appropriate playback system for that form of data. If the playback device is a computer, to play an animation within a segment of a multimedia work, the computer must have available in its internal memory (for example RAM memory) the data for the animation as well as the appropriate application program needed to playback the animation. For example, a segment of a multimedia work may contain an animation for which the animation data is stored in Macromedia Flash (SWF) file format. In order for the computer to display the animation, the computer's processor must have access to a Macromedia Flash player (software that allows the display of SWF data) as well as to the SWF data itself.

For many forms of multimedia, each segment of multimedia is represented by one or more “frames” of content. Like frames of a conventional movie film, a frame encapsulates content and is temporally separated from other frames. The resulting sequence of frames may be described as a “timeline”. Unlike a movie film however, the amount of information required to describe the content of each frame may vary; normally only requiring the relative changes between two consecutive frames to be described for and interpreted by the playback device.

For example, an animation showing a cat walking past a house may consist of 8 frames. The first frame may contain information which, when processed by the display device, draws a house in the centre of the display and a cat to the left of the house. Subsequent frames may provide only information the display device doesn't already have, including changes in the cat's footing, posture and relative position. The player device does not need information describing the house again as this information remains in the player device and is shown from frame to frame. When played from frame to frame in rapid sequence, the impression of a cat walking past a house is created.

Many forms of multimedia allow a frame of information or consecutive frames of information to be played with a separate timeline to that of the main movie itself. This separate sequence of frames with its own timeline is known as a sub-movie. Sub-movies may also be played (or “nested”) within the timelines of other sub-movies.

When loaded by the playback device, a sub-movie is not immediately played but rather stored in memory. When specifically instructed to do so, a copy (or “instance”) of the sub-movie is created and displayed and may be manipulated within the timeline(s) of the multimedia work at one or more locations. For example, in the example of the house and cat animation above, the same sequence of frames could be encoded as a first sub-movie and nested within a 1-frame main movie. When played, the main movie would call the instance of the first sub-movie to be displayed, effectively displaying the same content as in the previous example. Extending the example further, a second sub-movie could be created depicting a potted plant. The second sub-movie could be temporally displayed within the first sub-movie and visually displayed within the window of the house. As the cat reached a specific, position within the animation, the image of the plant could be manipulated to provide the impression of wobbling. The resulting animation would be a cat walking past a house, with one of the windows of the house displaying a potted plant that wobbles as the cat passes.

Typically, the instructions for a multimedia work are created by an author using an authoring application, and the instructions are stored in a digital file that is processed by a playback device. The instructions themselves may be stored in binary format, text, or a combination of both. The instructions and data within a file are typically stored in identifiable blocks. Identifiers (or “tags”) at the beginning of each respective block indicate to the playback device how the block should be processed.

Files may be structured using tagged blocks where transmission from a storage device, such as a web-server, to a playback device, such as a web-browser on a desktop computer, may be perceived by an end-user as unacceptably slow. By providing tagged blocks that may be individually parsed and interpreted by the playback device as they arrive, it is possible for the file to be “streamed”; thereby allowing content in frames at the beginning of the timeline to be played back before the entire file is transmitted.

Common forms of tagged blocks are definition blocks and control blocks. Definition blocks define shapes, text, and other content. Control blocks provide instructions directly to the playback device as to the manner and timing in which the defined objects are presented. Framescript blocks (a type of control block) contain executable code for modifying the presentation at runtime. For example, a tagged control block within a sequence of blocks may indicate to the playback device to present a frame of information based on information provided in the preceding group of blocks.

As the file is streamed to the playback device, the blocks are read, saved to memory and processed according to the nature of their tags. However, due to the non-linear, interactive nature of many multimedia protocols, tagged blocks may be loaded, read and saved that are not directly relevant to the next frame or segment to be displayed. Even where a block is not immediately relevant, it is possible that, when processed, the block affects other values or operations handled by the playback device that are relevant. As a consequence, changing or amending blocks within the data file that will be used by the playback device must recognize in many cases the non-linear order in which the blocks could be processed.

If a playback device used for presenting a multimedia work is able to instantaneously load all data and application code needed to present the multimedia work, a transition from one frame to the next can therefore be made nearly instantaneously. Even where the data does not load quickly, it may be possible for the playback device to present consecutive frames nearly instantaneously if a) the playback device is able to play one or more frames before fully loading the work, and b) subsequent frames can be loaded and played back at a sufficient rate that the transition from one frame to the next is not delayed.

In general however, the transfer rate of the work is limited by the bandwidth of the connection (for example, an Internet dial-up connection) between the storage device (for example, a web server) and the display device (for example, a desktop computer with a web browser). Consequently, significant delays can occur between the transitions from one frame to the next when the work is presented.

Two undesirable outcomes are associated with this delay between frames. First, end-users viewing the presentation of the multimedia work can misidentify this operational delay as a technical fault and cease viewing the work. Second, aesthetic and functional aspects of the work can be sufficiently compromised that the value of the multimedia work is diminished.

To overcome these two issues, authors of multimedia works often include a ‘preloader’ segment at the beginning of their work that: a) delays playback of the work until a sufficient amount of the file is loaded by the playback device so that the transition between frames can be made without delay, and b) displays an indicator, typically in the form of a counter or progress bar, that alerts the end-user to the expected delay created by the caching of the file and thereby mitigates the impression of a technical or operational fault.

At a programmatic level, the logic of a preloader is relatively simple. When the movie begins, the preloader is executed first. The initial state of the preload indicator is presented. A cycle begins (normally over a sequence of two or more frames) where the current amount of bytes loaded is periodically checked and the indicator updated. When a designated amount of bytes loaded is achieved the preloader segment stops and the remainder of the movie is presented.

While preloaders are a useful solution, they can be technically challenging and laborious to create. For many authors, the programmatic and functional aspects of a preloader are significantly more sophisticated than the main segments of the multimedia work themselves.

Previous attempts have been made to reduce the skill and effort required to create a preloader by providing a customizable software module (or “component”) for use at time of authoring. Typically these modules allow the introduction of a pre-designed preloader segment into an authoring file prior to the output of a multimedia work. The author may set the customization of such attributes as size, colour, position, text, etc. While these components provide a simpler means for creating a preloader at the authoring stage, their inclusion within the work is not always compatible with existing instructions within the multimedia work, particularly where one or more framescript instructions are present in the first frame of a pre-existing work. Furthermore, changing the data file at a subsequent stage requires the use, in many cases, of the original authoring file from which a new data file must be created. Authors may wish to edit the data file directly as a result of personal preference, work-flow requirements or inability to retrieve a working copy of the authoring file. In such cases, the component solution will not satisfy their needs.

Other attempts have been made to provide template authoring files that include customizable preloaders. While these templates provide a simpler means for creating a preloader at the authoring stage, their inclusion with the work may introduce aesthetic or functional limitations that are undesirable to the author. For similar reasons noted above, editing the data file at a subsequent stage requires the use, in many cases, of the original authoring file from which a new data file must be created. Authors may wish to edit the data file directly as a result of personal preference, work-flow requirements or inability to retrieve a working copy of the authoring file. In such cases, the template solution would not satisfy their needs.

Other attempts have been made to combine two data files of multimedia works together so as to introduce a preloader into an existing work. If a preloader were represented by a first data file, and the body of work by a second data file, combining the files together could achieve the desired outcome. This method can be successful, but again, functional difficulties arise if, for example, absolute frame references are used in the existing work. Introducing additional frames to the beginning of the timeline of the main body would cause absolute frame references to target frames before those to which they are intended.

If an author always created a body of multimedia work without framescript in the first frame of the work and used relative rather than absolute frame references in conjunction with executable statements, the use of such components or combining method would generally be successful. However, in practice this limitation may compromise the aesthetic and functional aspects of many works. There remains a need for a method to include a preloader within a multimedia data file, regardless of the presence of framescript within the first frame or absolute frame references within executable statements.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect, the present invention provides a method for integrating at least one segment of a first multimedia work into a second multimedia work to produce a combined multimedia work, the method comprising:

inserting the at least one segment of the first multimedia work into the second multimedia work; and

updating instructions in the combined multimedia work in order to maintain the function of the instructions.

According to a second aspect, the present invention provides a system for integrating at least one segment of a first multimedia work into a second multimedia work to produce a combined multimedia work, the system comprising:

means for inserting the at least one segment of the first multimedia work into the second multimedia work; and

means for updating instructions in the combined multimedia work in order to maintain the function of the instructions.

According to a third aspect the present invention provides a computer program for integrating at least one segment of a first multimedia work into a second multimedia work to produce a combined multimedia work, the computer program comprising:

code for inserting the at least one segment of the first multimedia work into the second multimedia work; and

code for updating instructions in the combined multimedia work in order to maintain the function of the instructions.

According to a fourth aspect the present invention provides a computer program element for integrating at least one segment of a first multimedia work into a second multimedia work to produce a combined multimedia work, the computer program element comprising:

computer program code means to make a computer execute a procedure to insert the at least one segment of the first multimedia work into the second multimedia work; and

computer program code means to make the computer execute a procedure to update instructions in the combined multimedia work in order to maintain the function of the instructions.

According to a fifth aspect, the present invention provides a method for integrating a first multimedia work and a second multimedia work to produce a combined multimedia work, the method comprising:

converting the first multimedia work into a sub-movie format;

inserting the converted first multimedia work into the second multimedia work as a sub-movie of the second multimedia work to produce a combined multimedia work; and

updating instructions in the combined multimedia work in order to maintain the function of the instructions.

Preferred embodiments of the present invention provide for integrating multimedia works for display on a playback device such as a personal computer with a web browser using the Flash Player plugin. The first and second multimedia works are preferably of the same format such as Macromedia Flash (SWF) format file. Alternatively, the first and second multimedia works may be of differing formats, and converted to a common format to enable integration in accordance with the present invention.

In particularly preferred embodiments, the present invention provides for integration and successive presentation of the first and second multimedia works, even in the presence of potentially conflicting instructions in the second multimedia work.

In preferred embodiments of the invention, the at least one segment of the first multimedia work is inserted before an initial segment of the second multimedia work. In such embodiments, the step of updating instructions preferably further comprises determining whether instructions exist that execute on the initial frame of the second multimedia work, and if so, amending such instructions in the combined multimedia work to delay execution of at least one segment of the second multimedia work until after completion of execution of the at least one segment of the first multimedia work. Preferably, further instructions are inserted into the combined multimedia work to execute with the first multimedia work and to track presentation of the first multimedia work and cause presentation of the second multimedia work following completion of the first multimedia work.

The present invention may be adapted for implementation at the time of authoring, where the combined multimedia work is stored in memory of the authoring device, for example a desktop computer using a multimedia application.

In some embodiments, the present invention may be adapted to integrate output files that contain the data needed to present the first and second multimedia works using a playback device, and to produce an output file containing the data needed to present the combined multimedia work using a playback device. Additionally, embodiments of the present invention may allow editing of the first and second multimedia works within an authoring environment or editing of the combined multimedia work within an authoring environment.

Embodiments of the invention may create or amend a data file of the first multimedia work such that it may be displayed as a sub-movie in the second multimedia file when processed by a playback device.

In preferred embodiments, the updating of instructions in the combined multimedia work may provide the ability to re-execute instructions whose execution has been specifically delayed to allow the successful playback of the sub-movie representing the first multimedia work.

In preferred embodiments, the updating of instructions in the combined multimedia work may comprise inserting instructions for creating a referencing system, for those instructions specifically delayed from executing, into the first frame of the main timeline, should no framescript exist in an initial frame of the second multimedia work.

In preferred embodiments, the updating of instructions in the combined multimedia work may comprise inserting into the first frame of the main timeline instructions for creating a referencing system for those instructions specifically delayed from executing and for delaying existing framescript, should framescript exist in the initial frame of the second multimedia work.

In preferred embodiments, the updating of instructions in the combined multimedia work may comprise inserting into a second frame of a main timeline or a second frame of a sub-movie instructions for returning a playback device to a first frame of a main movie should the playback of the sub-movie representing the first multimedia work be incomplete, should there be no existing framescript.

In preferred embodiments, the updating of instructions in the combined multimedia work may comprise inserting into a second frame of a main timeline or a second frame of a sub-movie instructions for returning a playback device to a first frame of a main movie should the playback of the sub-movie representing the first multimedia work be incomplete, and for ignoring remaining existing framescript in that frame.

In preferred embodiments, the updating of instructions in the combined multimedia work may comprise inserting into a first frame of a sub-movie, appearing in the first frame of a main timeline of the second multimedia work, instructions for delaying the execution of existing framescript until the sub-movie representing the first multimedia work is complete.

In preferred embodiments, the updating of instructions in the combined multimedia work may comprise inserting instructions for delaying execution of an event-based, instance-specific instruction into the frame where the instance-specific instruction exists such as into the first or second frame of a main timeline, or into the first or second frame of a sub-movie timeline that is displayed in the first or second frame of the main timeline, the inserted instructions adopted to delay execution of the instance-specific instruction until completion of playback of the first multimedia work.

In preferred embodiments, the updating of instructions in the combined multimedia work may comprise inserting into the first or second frame of a main timeline, or the first or second frame of an existing sub-movie timeline that is displayed in the first or second frame of the main timeline, instructions that pertain to the event of displaying a specific instance of a sub-movie and to facilitating a means for executing those instructions, should the playback of the sub-movie representing the first multimedia work not be complete, and should no instructions exist that relate to the presentation of that specific instance.

In preferred embodiments, the updating of instructions in the combined multimedia work may comprise inserting into the first or second frame of a main timeline, or the first or second frame of an existing sub-movie timeline that is displayed in the first or second frame of the main timeline, instruction for delaying execution of existing instructions that pertain to the event of displaying a specific instance of a sub-movie, and for facilitating a means for re-executing those delayed instructions, should the playback of the sub-movie representing the first multimedia work be complete or otherwise.

In preferred embodiments, the updating of instructions in the combined multimedia work may comprise inserting into the first or second frame of a main timeline, or the first or second frame of an existing sub-movie timeline that is displayed in the first or second frame of the main timeline, instruction for delaying execution of existing instructions that define aspects of instances of a sub-movie before an instance of the sub-movie is first created, and for creating a referencing system for such delayed instructions, and for creating a reference to the delayed instructions should the playback of the sub-movie that represents the first multimedia work not be complete, and for executing the delayed instructions should the playback of the sub-movie representing the first multimedia work be complete.

In preferred embodiments, the updating of instructions in the combined multimedia work may comprise inserting into the first or second frame of a main timeline, or the first or second frame of an existing sub-movie timeline that is displayed in the first or second frame of the main timeline, instructions that provide for existing instructions that define the properties and/or attributes of an instance of a sub-movie at the time of its creation to be referenced and executed as required.

### BRIEF DESCRIPTION OF THE DRAWINGS

Examples of the invention will now be described with reference to the accompanying drawings in which:

FIG. 1 illustrates a typical preload indicator;

FIG. 2 is a flowchart illustrating the stages of the multimedia work lifecycle;

FIG. 3 is a schematic diagram illustrating an example of data blocks within a multimedia work and the manner in which they are processed by a playback device;

FIG. 4 is a flowchart illustrating an overview of the logic used to combine newly authored segments with code block A;

FIG. 5 is a flowchart illustrating the basic logic of a preloader algorithm;

FIG. 6a is a flowchart illustrating an overview of the logic used to combine segments from Movie 1mod with segments from Movie 2 and code block types B, C, D and E;

FIG. 6b is a flowchart of the logic of algorithm Z of FIG. 6;

FIG. 7 is a flowchart illustrating the detailed logic used to combine the segments from Movie 1mod with segments from Movie 2 and code block types B, C, D and E;

FIG. 8 is a block diagram illustrating the sequence of blocks in example Movies M1, M2 and M3;

FIG. 9 is a schematic diagram representing the possible sequences in which the blocks may be executed;

FIG. 10 is a flowchart of the playback behaviour of block A;

FIG. 11 is a flowchart of the playback behaviour of Code B.1;

FIG. 12 is a flowchart of the playback behaviour of Code B.2;

FIG. 13 is a flowchart of the playback behaviour of Code C.1;

FIG. 14 is a flowchart of the playback behaviour of Code C.2;

FIG. 15 is a flowchart of the playback behaviour of Code D;

FIG. 16 is a flowchart of the playback behaviour of Code E.1;

FIG. 17 is a flowchart of the playback behaviour of Code E.2;

FIG. 18 is a flowchart of the playback behaviour of Code E.3;

FIG. 19 is a flowchart of the playback behaviour of Code E.4; and

FIG. 20 is a flowchart of the playback behaviour of Code E.5.

### DETAILED DESCRIPTION OF THE PREFERRED EMBODIMENTS

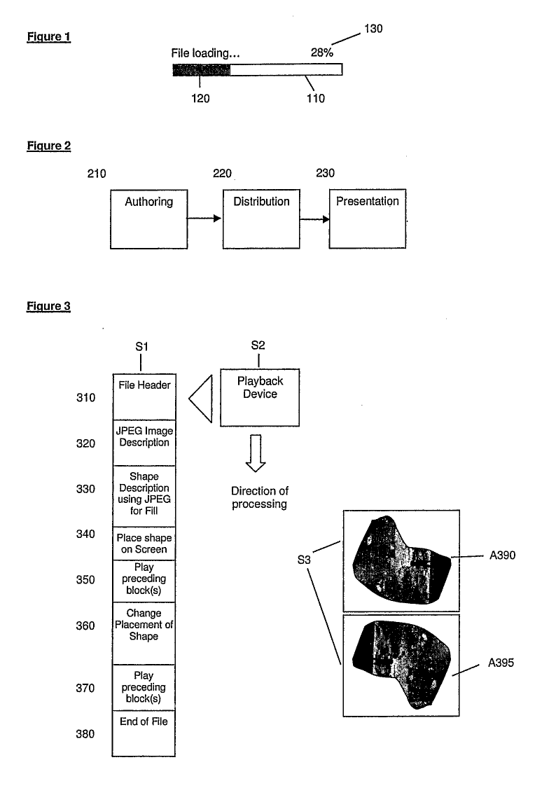

FIG. 1 is an illustration of a preloader indicator which may be displayed by a playback device. The indicator is displayed at the beginning of a movie's presentation. The progress bar 120 and the percentage counter 130 are updated in real time to indicate to the end-user the progress of the file loading process. The bounding box 110 provides a relative indication of the total amount of bytes expected to load. Preloader indicators take many different forms.

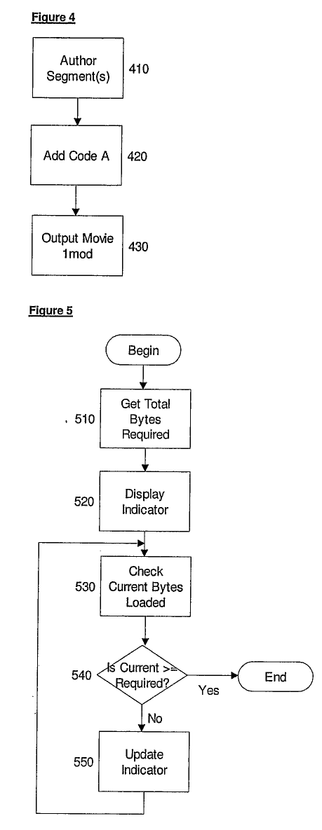

FIG. 2 is a flowchart illustrating the phases of the multimedia lifecycle. A multimedia work is first created using a multimedia application in the authoring process 210. As a finished work or as a work in progress, the multimedia work may be stored as an output file. In the distribution process 220, the output file is transferred from the author to the end-user. For example, where the multimedia work is published as part of a web page, the output file may be uploaded to a web server and listed in the index of a web page. When an end-user directs a web browser to the web page, the file is delivered from the web server to the end-user's computer. In the presentation process 230, the protocol used by the multimedia file is recognized and the appropriate application is employed to playback the data contained within the file. For example a Flash Player browser plugin would be used to playback a Flash (SWF) file.

FIG. 3 is a block diagram and graphic representation illustrating the relationship between the instructions contained within a multimedia file S1, a playback device S2 and a display of the multimedia work S3. Blocks 310, 320, 330, 340, 350, 360, 370 and 380 represent consecutive instructions contained within an example multimedia file S1. The blocks are processed in order by the playback device S2. The playback device is typically a computing device, such as a personal computer using a web browser, with the ability to call additional applications or decoding algorithms as necessary to interpret the contents of a multimedia file. S3 is a display device, for example a CRT monitor, which displays to the end-user the content of the multimedia presentation.

The first instruction 310 is an instruction that is typically included at the beginning of a file to indicate to the playback device the protocol of the file and other general information relating to its execution (commonly known as a “header” block). In the present embodiment, the second block 320 describes an image that is read and stored by the playback device S2. The third block 330 is a description of a shape outline that is read and stored by the playback device S2. The description specifies that the previously defined image is used as the fill for the shape. The fourth block 340 is an instruction to draw the shape at a specific location on playback. The instruction is read and stored by the playback device S2. The fifth block 350 is an instruction to the playback device S2 to process the preceding blocks in such a way that the image A390 is generated on the display device S3. The sixth block 360 is an instruction to draw the shape described in 330 at a new location and orientation. This instruction is read and stored by the playback device S2. The seventh block 370 is a similar instruction to that of 350 and instructs the playback device S2 to process the preceding blocks in such a way that the image A395 is generated on the display device S3. Typically a playback device processes only those blocks subsequent to the previous process command 350, in this scenario, block 360. The eighth block 380 indicates to the playback device S2 that the file is complete and no further instructions follow.

FIG. 4 is a flowchart illustrating the process by which one or more segments of a multimedia work may be authored and prepared for inclusion with one or more segments of an existing second multimedia work to become a combined work. At 410, the author of the work uses an authoring application to create one or more segments for inclusion in the combined work. At 420, Code A is appended to the authored segment(s). Finally, the output file Movie 1mod is created at 430.

A significant aspect of Movie 1mod is its ability to be interpreted and manipulated by the playback device as a sub-movie and thus avoid disturbing the existing length of the main timeline. The instructions in Code A provide this facility. As a sub-movie, the Movie 1mod may then be ‘attached’ at run-time to the beginning of the movie and, in combination with the deferment of playback of other existing segments, allow the Movie 1mod (which contains the preloader) to be successfully played back prior to all other segments.

FIG. 5 is a flowchart illustrating the logic of an example preloader when executed in a playback device. At 510, the preloader determines what number of bytes must be loaded to satisfy its termination condition; for example, the total file size of the multimedia work. At 520 the indicator is displayed by the playback device. The indicator may for example, appear like the indicator in FIG. 1. At 530 the preloader checks the current number of bytes loaded and begins a loop that continually checks and updates this information. At 540 the current number of bytes is compared to the total number required. If the current number if less than the total, 550 is executed. If the amount is equal to or more than the total required, the process ends. At 550 the indicator is updated using the current number of bytes and the process loops back to 530 again.

For practical purposes, this loop is normally achieved using two or more frames within the movie timeline as represented in the data file and interpreted by the playback device. For example, the indicator may be displayed and updated using the current number of bytes on frame 1. On frame 2, the cache memory is queried for the number of bytes currently loaded. If the required total has not been achieved, the playback device is instructed to return to and play frame 1 again, else the playback device proceeds to frame 3 (if it exists) or ends.

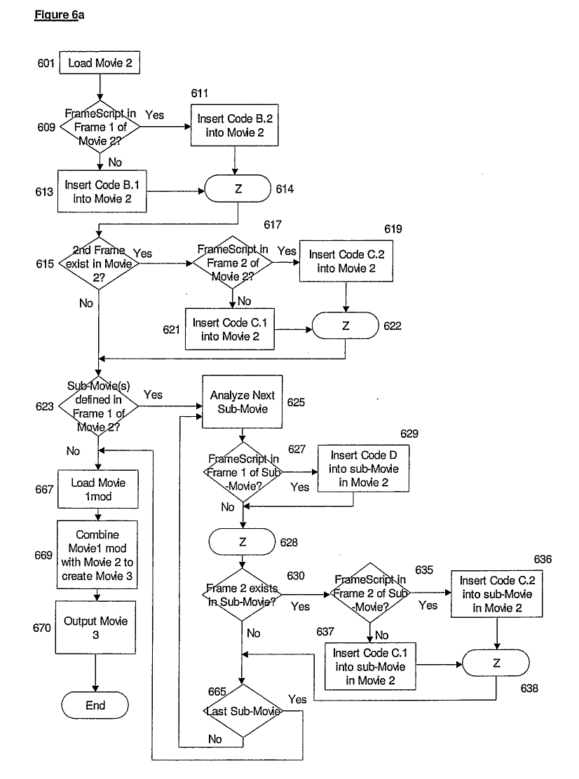

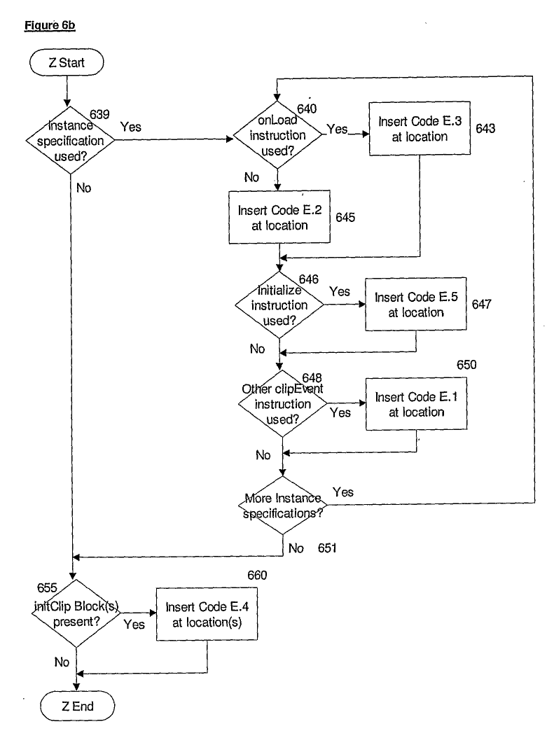

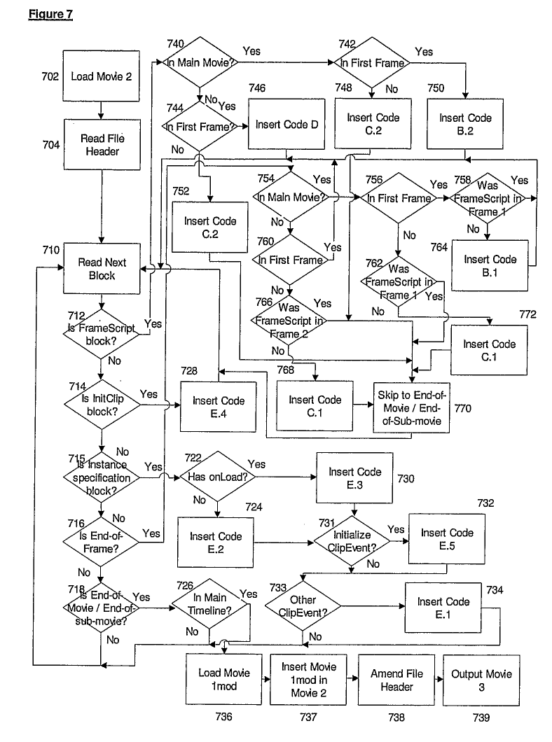

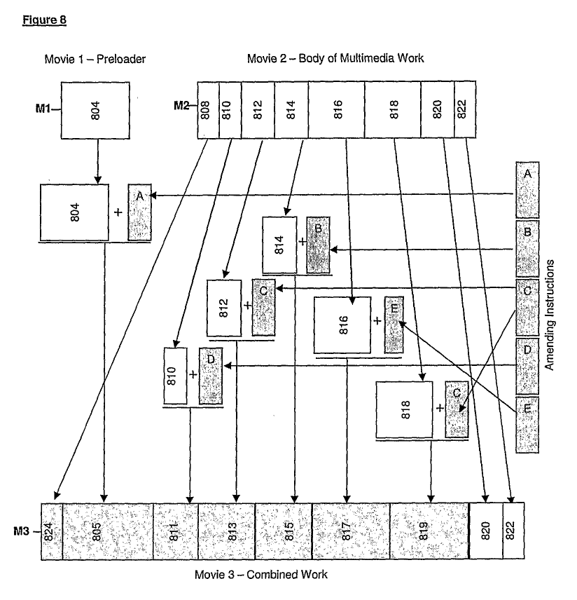

FIG. 6 is a flowchart illustrating an overview of the logic employed to combine a multimedia segment or segments with an existing multimedia work. The process assumes code A has been previously combined with a segment or segments to create Movie 1mod and uses code B.1, B.2, C.1, C.2, D, E.1, E.2, E.3, E.4 and E.5 as required to complete the integration of the segments into a single file, Movie 3.

The addition of blocks B.1 through E.5 is made necessary by the treatment of the preload segment as a sub-movie. If no alterations other than the introduced Movie 1mod were made, instructions contained within the first frame of the main timeline or instructions contained within the first frame of sub-movies associated with the first frame of the timeline would be executed prior to the completion of the preloader sub-movie. Likewise, following execution of the second frame of the preloader, instructions in the second frame of the main timeline and/or the second frame of sub-movies associated with the first frame of the main timeline would be executed prior to the preloader looping back to its first frame.

Executing framescript or other specific instructions in these locations could have a detrimental effect on successful playback of the Preloader segment. For example, the framescript may require that a segment be played immediately, inadvertently interrupting the completion of the preloader, One solution is to add code blocks to the first frame of the main timeline (Type B) or the first frame of sub-movies associated with the first frame of the main timeline (Type D or E) that will rewrite potentially problematic code as functions. Similarly, adding code blocks to the second frame of the main timeline, or the second frame of sub-movies associated with the first frame of the main timeline (Type C or E), can rewrite existing problematic code as functions. In the form of functions, the code in these frames may be delayed from executing and called again once the preload segment has successfully completed.

In addition to averting the interruption of the preloader, the introduced blocks address one or many of the following tasks. First, instructions may be provided in the first frame of the main timeline that attach the Preloader to the beginning of the movie. Second, instructions may be provided to record and make addressable those functions and/or sub-movie instances for which instructions have been rewritten as functions, thereby allowing them to be specifically executed once the preloader segment is complete. Third, instructions may be provided to execute the instances of sub-movies and/or functions when the preloader segment is complete. Fourth, a means may be created to indicate when Movie 1mod has successfully completed so that the above instructions are not mistakenly re-executed.

With these objectives in mind, it is possible to more fully describe the additional blocks that are inserted into the combined movie to ensure its successful playback.

B.1 is a code block that is inserted at the beginning of frame 1 of the main timeline where it is executed before any other block in the frame. It is used specifically for frame 1 of a main movie timeline that does not include framescript. Within the playback sequence of instructions held in the memory of the playback device, B.1 first attaches an instance of the Movie 1mod sub-movie so that Movie 1mod will be played first on playback of the timeline. Second, B.1 creates an indicator (or ‘flag’) that may be set by Movie 1mod to indicate that the preloader has successfully completed. Third, B.1 creates a referencing system within the playback device to track instances of sub-movies whose instructions have been rewritten as functions. Fourth, B.1 contains instructions to skip the above instructions if the Preloader has been previously executed. Lastly, B.1 provides instructions to the playback device to play the main movie from its first frame so that Movie 1mod may be executed.

B.2 is similar to B.1 in all respects except a) it is used where framescript code exists in the first frame of the main movie, b) it includes instructions to rewrite existing framescript as a function, and c) the function is to be executed if Movie 1mod is complete.

C.1 is a code block that is inserted at the beginning of frame 2 of the main timeline or at the beginning of frame 2 in a sub-movie timeline where the sub-movie is associated with the first frame of the main timeline. It is used in those specific frames where no framescript previously exists. The purpose of C.1 is to prevent the execution of the contents of the frame in which it is placed before Movie 1mod is complete.

C.2 is similar to C.1 in all respects except a) it is used where framescript code already exists in the specified frame, and b) it may include instructions that specifically force the playback device to ignore other instructions contained within the current frame.

D is a code block that is inserted at the beginning of frame 1 of a sub-movie, that contains framescript and is associated with the first frame of the main-timeline. When executed, D determines if Movie 1mod has successfully executed. If Movie 1mod has not executed, the framescript is rewritten as a function and referenced in the reference system created by either B.1 or B.2 for later execution. If Movie 1mod has executed, the function, if it has been previously created, is executed.

E.1, E.2, E.3, E.4, and E.5 code blocks specifically address issues associated with the use of sub-movies within the playback device and the potential interruption of the preloader segment. In general, the blocks rewrite problematic instructions as functions and execute these instructions once Movie 1mod is complete. More specific discussion of these code blocks follows.

E.1 modifies an existing event-driven instruction that pertains to the behaviour of a specific instance on playback (or a “clipevent” instruction), except where the instruction defines the properties and/or attributes of a specific instance at the time of its creation (or an “initialization” instruction) or where the instruction pertains to the event of displaying the instance once created (or an “on Load” instruction). When executed, E.1 only executes these instructions if Movie 1mod is complete.

E.2 is inserted where no existing instruction is provided that relates to the event of displaying a specific instance of a sub-movie once created (or an “on Load” instruction). When executed, E.2 creates a reference to the instance if Movie 1mod is not complete. The reference is later used in the execution of Block A.

E.3 modifies an existing instruction that relates to the event of displaying a specific instance of a sub-movie once created (or an “on Load” instruction). When executed, E.3 rewrites the on Load instruction as a function and creates a reference to the instance for use by Block A if Movie 1mod is not complete. The function is then executed.

E.4 modifies an existing instruction that is specific to a sub-movie, and is executed prior to the creation of the first instance of that sub-movie (or an ‘initClip’ instruction). When executed, E.4 rewrites the instruction as a function if Movie 1mod is not complete and creates a reference system (if necessary) for referencing the function during the execution of Block A. If Movie 1mod is complete, E.4 executes the function.

E.5 modifies an existing instruction that defines properties and/or attributes of a specific instance at the time of its creation (or an “initialization” instruction). When executed, E.5 rewrites and executes the instruction as a function.

Table A summarizes the relationship between code blocks, timelines and frame numbers.

TABLE A
Code Insertions for frame and timeline structure of Movie 2

| | | Sub-Movie |
|---|---|---|
| Frame | Main Timeline | Timeline |
| 1 | Work 1mod (incl. A) | D |
| | B.1 or B.2 | E.1? |
| | E.1? | E.2 or E.3? |
| | E.2 or E.3? | E.4? |
| | E.4? | E.5? |
| | E.5? | |
| 2 | C.1 or C.2 | C.1 or C.2 |
| | E.1? | E.1? |
| | E.2 or E.3? | E.2 or E.3? |
| | E.4? | E.4? |
| | E.5? | E.5? |

Table B summarizes the conditions under which a code block is inserted during the authoring process and the purpose the code block serves when executed by the playback device.

TABLE B

| Code | | |
|---|---|---|
| Name | Insertion Protocol | Key Playback behaviour |
| Movie | Always inserted | Is interpreted as a sub-movie by the |
| 1mod | | playback device |
| | | Segments from Movie 1mod are |
| | | played first |
| | | If Movie 1mod is not complete, will |
| | | display preloader and update indicator |
| | | Delays and re-plays instances and |
| | | functions |
| | | Removes self on completion |
| B.1 | Inserted into 1^{st} frame code of main | Attach Movie 1mod |
| | timeline where no framescript | Creates reference mechanisms for |
| | exists previously. | sub-movies with rewritten functions |
| B.2 | Inserted into 1^{st} frame code of main | Attach Movie 1mod |
| | timeline where framescript exists | Creates reference mechanisms for |
| | previously | sub-movies with rewritten functions |
| | | Rewrites and executes original |
| | | framescript as function |
| C.1 | Inserted into 2^{nd} frame code of | If Movie 1mod not complete |
| | main timeline or 2^{nd} frame of sub- | Returns playback device to 1^{st} |
| | movie appearing in 1^{st} frame of | frame of main movie |
| | main movie where no framescript | |
| | exists previously | |
| C.2 | Inserted into 2^{nd} frame code of | If Movie 1mod not completed |
| | main timeline or 2^{nd} frame of sub- | Skips existing code in frame |
| | movie appearing in 1^{st} frame of | Returns the playback device to 1^{st} |
| | main movie where framescript | frame of main movie |
| | exists previously | |
| D | Inserted into 1^{st} frame code of sub- | Encapsulates original framescript in |
| | movie timeline appearing in 1^{st} | frame as function statements |
| | frame of main timeline where | Plays function when Movie 1mod is |
| | executable statement exist | completed |
| | previously. | |
| E.1 | Modifies an event-based | Rewrites instruction(s) as function |
| | instruction that pertains to the | Plays function when Movie 1mod is |
| | behaviour of a specific instance on | completed. |
| | playback, other than instructions | |
| | addressed by E.3 and E.5. | |
| E.2 | Inserted where an instruction calls | Provides a means for addressing |
| | for the display of a specific | loaded sub-movie instances. |
| | instance and no pre-existing | |
| | instruction exists pertaining to the | |
| | event of displaying that instance. | |
| E.3 | Modifies a pre-existing instruction | Rewrites instruction as function. |
| | pertaining to the event of | Plays function when Movie 1mod is |
| | displaying a specific instance. | completed |
| E.4 | Modifies an existing instruction | Rewrites instruction code as a |
| | that is specific to a sub-movie and | function |
| | is executed prior to the creation of | Creates reference mechanism for |
| | the first instance of that sub-movie. | functions created by E.4 |
| | | Plays function when Movie 1mod is |
| | | completed |
| E.5 | Modifies an existing instruction | Rewrites instruction as a function. |
| | that defines properties and/or | Plays function when Movie 1mod is |
| | attributes of an instance at the time | completed |
| | of its creation. | |

With reference to FIGS. 6a and 6b, the process begins at block 601 where the existing multimedia work (Movie 2) is loaded. At 609, frame 1 of the main timeline of Movie 2 is searched to determine if any framescript blocks exist. If framescript blocks do exist, code block B.2 is inserted at the beginning of the frame at 611 replacing any existing framescript, before executing the algorithm Z at 614. Algorithm Z is explained in the following with reference to FIG. 6b. If no framescript exists at 609, code block B.1 is inserted into the beginning of the first frame at 613, before executing the algorithm Z at 614.

Following the completion of algorithm Z at 614, the process checks if a second frame in the main timeline of Movie 2 exists at 615. If the frame does exist, the frame is checked at 617 to determine if a framescript block or blocks exist within that frame. If framescript blocks do exist, at 619 code block C.2 is inserted, replacing existing framescript, before executing algorithm Z at 622. If no framescript blocks exist at 617, the process proceeds to 621 where code block C.1 is inserted at the beginning of the frame, before executing the algorithm Z at 622. If no second frame exists at 615, or following the completion of algorithm Z at 622, the logic proceeds to 623.

It is possible during loading and processing of tagged data blocks pertaining to an instance or instances of a sub-movie that such tagged data blocks may be processed prior to the execution of Movie 1mod. It is therefore necessary to introduce code where necessary to avoid the possibility that an instance or instructions relating to an instance be executed in such a way that is incompatible with the playback of Movie 1mod. At 623 Movie 2 is analysed to determine those sub-movies that are defined in the first frame of the main timeline of Movie 2. If a qualifying sub-movie or sub-movies exist, a loop process begins at 625, else the process proceeds to 667. At 625, beginning with the first sub-movie encountered, the first frame of the sub-movie timeline is checked at 627 for the presence of framescript. If a framescript block is present, code D is inserted at 629, amending or replacing existing code, and the process proceeds to 628 where algorithm Z is executed. If no framescript is present, the process proceeds directly to 628. When algorithm Z is complete at 628, the existence of a second frame in the sub-movie timeline is determined at 630. If no second frame exists, the process proceeds to 665, otherwise the logic proceeds to 635. At 635 the second frame is checked for a framescript block or blocks. If a framescript block exists, code C.2 is inserted, amending or replacing existing code, at 636. If no framescript blocks exist, code C.1 is inserted at the beginning of the frame at 637. Subsequent to the insertion of either code C.1 or C.2, algorithm Z is executed at 638.

Following 638, a decision point determines if additional sub-movies require processing at 665. If additional sub-movies do require processing, the process returns to 625. If no further sub-movies exist, 667 is enacted. At 667, the amended multimedia segments created previously, Movie 1mod (see FIG. 4) is loaded. Movie 1mod is then inserted into a copy of Movie 2 at 669 to become Movie 3. At 670, all necessary modifications to Movie 3 are considered complete and the multimedia work is outputted ready for playback.

Algorithm Z is executed at 614, 622, 628 and 638 respectively and represents a generic algorithm that checks for and modifies instructions in the current frame associated with specific aspects of creating and displaying instances. As set out in FIG. 6b, when executed, the algorithm Z first checks for instructions that specify the instance at 639. If no such instructions are present, the logic continues to 655. If such instructions are present, 640 is enacted.

At 640 the sub-movie is checked for the presence of an event based instruction that specifically relates to the event of presenting an instance of a sub-movie once created (or an “on Load” instruction). If the instruction does not exist, code E.2 is inserted at 645 to provide an on Load instruction. If an on Load instruction already exists, the instruction is modified and amended with code E.3 at 643. Subsequent to the insertion of either E.2 or E.3 at 645 or 643 respectively, the presence of an instruction that defines the properties and/or attributes of a specific instance at the time of its creation (or “initialize” instruction) is checked at 646. If the instruction exists, code E.5 is inserted at 647 before proceeding to 648. If no initialization instruction exists, the process continues directly from 646 to 648. At 648 the presence of any other event-related instructions pertaining to the instance of a sub-movie (or “clipEvents”) is checked. If a clipEvent does occur, code block E.1 is inserted at 650 before proceeding to decision point 651. Else the process proceeds directly to 651.

At 651 a decision point determines if any further instance specifications remain within the frame. If instance specifications do remain, the process returns to 640, else the process continues to 655.

At 655 the presence of an instruction that is specific to a sub-movie and is executed prior to the creation of the first instance of that sub-movie (or ‘initClip’) is determined. If such an instruction exists, code block E.4 is inserted, replacing the existing instruction within the initClip at 660. If no initClip exists or following the insertion of E.4, algorithm Z terminates and the logic returns to the point at which the algorithm was executed.

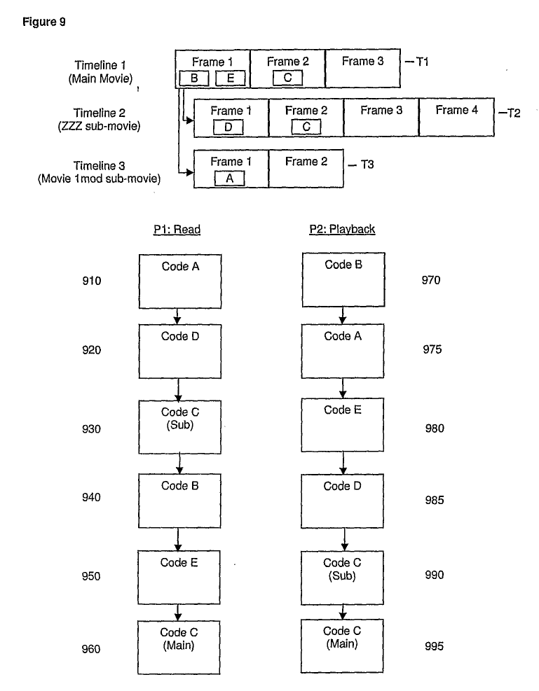

FIG. 7 is a flowchart illustrating in detail the logic employed to combine a multimedia segment or segments with a separate multimedia work. The process assumes block A has been previously combined with a segment or segments to create Movie 1mod. Code B.1, B.2, C.1, C.2, D, E.1, E.2, E.3, E.4 and E.5 are inserted into, modify or replace in whole existing code as required to complete the integration of the segments into a single file, Movie 3. While FIGS. 6a and 6b provide general overview of the creation process, FIG. 7 recognizes and incorporates the block-by-block process utilized by the playback device as illustrated in FIG. 3.

The process begins at 702 where the second multimedia work, Movie 2, is loaded. At 704 the file header information is read to determine the total length of the movie. At 710 a loop process of checking each successive block begins until an end-of-movie block is encountered in the main timeline of the movie. At 710 the next block is read. A decision point at 712 determines if the block contains instructions describing content of the frame (or ‘framescript’). If the block does not contain framescript, the process continues to decision point 714. At 714, the block is checked to see if it contains an initClip instruction. If no exception script is present at 714, the process continues to decision point 715 where the presence of an instruction that specifies a specific instance is checked. If no specification instruction exists, the process proceeds to 716 to detect if the block is an end-of-frame instruction (either in the main movie or in a sub-movie). If no end-of-frame instruction is encountered at 716, the block is checked at 718 to determine if it is an end-of-movie instruction in either the main movie or a sub-movie. If not, the process returns to the beginning of the loop at 710. If an end-of-movie instruction is encountered, the process proceeds to 726 where it is determined to be an instruction relevant to the main movie or a sub-movie. If the end-of-movie is provided for a sub-movie, the process returns to the loop at 710, else the loop ends and proceeds to 736.

At 736 Movie 1mod is loaded and inserted into Movie 2 at 737. At 738 the file header is amended to account for the additional code included in the file size before proceeding to 739 where the combined multimedia work, Movie 3, is outputted and the process ends.

If at 712 a block containing framescript is encountered, the process proceeds to decision point 740 where it is determined whether the block is in the main movie or a sub-movie. If the block is in a sub-movie, the process determines at 744 if the block is in frame 1 of the sub-movie. If the block is not in the first frame (and therefore is in the second frame), code block C.2 is inserted prior to the block in question at 752. The process then proceeds to 770. To reach 770, the logic of the algorithm is such that the analysis is complete for the first two frames of the current timeline. As only the first two frames require analysis and modification when using a two-frame preloader, subsequent frames can safely be ignored. Therefore, any remaining blocks before the end of the current timeline are skipped and the process loops back to 710 where the next block is read.

If at 740, a block containing framescript was found to be in the main movie, its presence in the first frame is then determined at 742. If the block is not in the first frame, it must therefore be in the second frame, and consequently code C.2 is inserted at 748. From 748 the process proceeds to 770 where the remaining blocks in the movie or sub-movie are skipped and the process returns to the loop at 710 where the next block is read.

If at 742 the block was in the main movie and in the first frame, code block B.2 is inserted before the block in question at 750. From 750 the process returns to the loop at 710 where the next instruction is read. If at 744 the block was in a sub-movie in the first frame, code block D is inserted before said block at 746. The process then returns to the beginning of the loop at 710 where the next block is read.

If at 714 an initClip block is identified, code E.4 is inserted at 728 before returning to the beginning of the loop at 710 where the next block is read.

If at 715 the block does contain an instance specification instruction, the process proceeds to 722 where it is checked for an on Load instruction. If it does not contain an on Load instruction, code block E.2 is inserted at 724 to provide an onLoad instruction before proceeding to 731.

If at 722 an on Load instruction is encountered, the process proceeds to 730 where the instructions are altered and code block E.3 is inserted before proceeding to 731.

At 731 the block is checked to determine if an ‘initialize’ instruction is used. If the instruction is present, code E.5 is inserted at 732 before proceeding to 733. If no initialize instruction is present, the process proceeds directly from 731 to 733.

At 733, the instruction is checked to determine if the block contains any other clipEvent instruction. If not, the process loops back to 710 where the next instruction is read. If another clipEvent instruction is present, code block E.1 is inserted at 734 before looping back to 710 where the next block is read.

If at 716, the block is determined to be an end-of-frame block, the process continues to 754. At 754 it is determined whether the block is present in the timeline of the main movie or the timeline of a sub-movie. If it is in a sub-movie, the process proceeds to 760, where it is determined whether the block is in the first frame of the sub-movie. If the block is not in the first frame of the sub-movie a determination is made at 766 whether framescript was previously detected in frame 2 of the current sub-movie. If no framescript was detected, code block C.1 is inserted at 768. From 768 the process proceeds to 770, where the process skips to the end of the movie or sub-movie before returning to loop at 710 where the next block is read.

If at 766 no framescript was previously detected in Frame 2 of the current sub-movie, the process proceeds directly to 770.

If at 760 the end-of-frame is determined to occur in the first frame of a sub-movie, the process returns to the beginning of the loop at 710 where the next block is read.

If at 754 the end-of-frame is determined to occur in the main movie, the process proceeds to 756 where it is determined whether the block is in the first frame of the timeline of the main movie. If the block is not in the first frame, it is determined at 762 whether framescript had previously been encountered in frame 1 of the main movie. If framescript was not detected, code block C.1 is inserted at 772 and the process proceeds to 770. If framescript was detected at 762, the process proceeds directly to 770.

If at 756 the end-of-frame block is in the main movie and in the first frame, the process proceeds to 758 where it is determined whether framescript was encountered in frame 1 of the main movie. If framescript was not encountered, code block B.1 is inserted at 764 and the process returns to 710. If at 758 it is determined that framescript was not encountered, the process returns directly to 710 where the loop process begins again.

FIG. 8 is a block diagram depicting an example of integration of a segment or segments from a first multimedia work (M1) with segments from a second multimedia work (M2) with other instructions (A, B, C, D and E) to form the combined multimedia work M3. Block 804 represents one or more segments from M1 to be played (for example, a preloader).

At M2, blocks 808 and 822 represent the header information and end-of-file instruction for M2 respectively. Block 810 is a block containing framescript pertaining to the first frame of a sub-movie that is defined on the first frame of the main movie. Block 812 is a block containing framescript pertaining to the second frame of the same sub-movie. Block 814 is a framescript block pertaining to the first frame of the main timeline. Block 816 is a block that specifies a specific instance of the said sub-movie for display. Block 818 is a framescript block pertaining to the second frame of the main timeline. Block 820 is a framescript block pertaining to the third frame of the main timeline.

When processed, block 804 is amended with code A to create block 805. 805 is inserted before the one or more segments in the work M3. Block 808 is modified as necessary (becoming block 824) to account for the changed file length of M3. Block 810 is combined with code D to create block 811 in M3. Block 12 is combined with code C to create block 813 in M3. Block 814 is combined with code B to create block 815 in M3. Block 816 is combined with code E to create block 817 in M3. Block 818 is combined with code C to create block 819 in M3. Block 820 remains unaltered and is included as block 820 in M3. Block 822 remains unaltered and forms the end-of-file block for M3.

FIG. 9 is a schematic diagram illustrating the difference between the relative order in which inserted codes A, B, C, D and E may be read by the playback device and the relative order in which the same code may be played back in the playback device. In this example, a main movie has two sub-movies, namely sub-movie ‘ZZZ’ and Movie 1mod. T1, T2 and T3 represent these timelines and their constituent frames respectively. T2 and T3 are configured to play in the first frame of T1. Code B followed by code E appears in the first frame of T1. Code C appears in the second frame of T1. Code D appears in the first frame of T2. Code C appears in the second frame of T2. Code A appears in the first frame of T3.

When read, the playback device processes each block as it appears in sequence within the data file. P1 represents a typical example of the sequence in which the code blocks A, B, C, D and E may be read by the playback device. Code A appears in the sequence first at 910, as the sub-movie Movie 1mod is inserted at the beginning of the data file. Code D appears second at 920, as it appears in the first frame of sub-movie ZZZ in the first frame of the main movie. The sub-movie code is declared in the data prior to any framescript reference to it in frame 1 of the main timeline. For similar reasons, code C (sub-movie) at 930 appears third, as it appears in the second frame of the sub-movie ZZZ in the first frame of the main movie. Code B appears fourth at 940 as it follows the sub-movie definition blocks but precedes the framescript blocks for the first frame of the main timeline. Code E appears fifth at 950 within the sequence as it is included within the instance specification code for ZZZ sub-movie in the first frame of T1. Finally Code C (main) appears at 960 when the blocks containing information for the second frame of T1 are read.

In contrast, P2 represents a typical example of the sequence in which the same code blocks A, B, C, D and E are played back by the playback device subsequent to being read in the sequence described by P1.

P2 illustrates the initial playback of each code block only. Code blocks may be played one or more times before the initial playback of a subsequent block in the sequence. Code B is played back first at 970, as it is configured to be the initial framescript present on frame 1 of T1. In the execution of B, an instance of the sub-movie Movie 1mod that contains A is assigned to play at the beginning of Frame 1. Code B then instructs the playback device to restart playing T1 from the beginning, this time executing the Movie 1mod and code A contained within it. In this example, code B is re-executed (not shown again in the sequence). Next, code E is executed at 980. Code E is part of an instruction to the playback device to place an instance of sub-movie ZZZ at a particular location in frame 1 of T1. The code is executed and T2 is played within the first frame of T1. As code D resides on the first frame of T2, it is played next at 985. The second frame of T2 contains code C (sub-movie) that is subsequently played back at 990. Finally, code C (main) is played back when the playback device plays the second frame of T1 at 995.

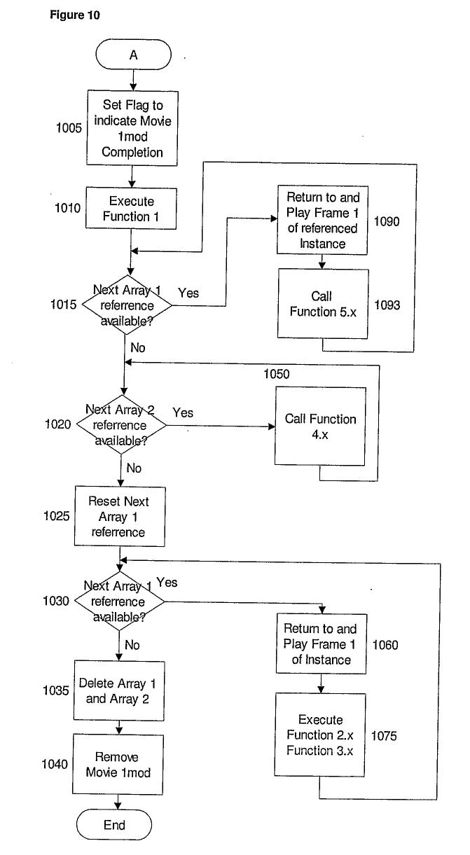

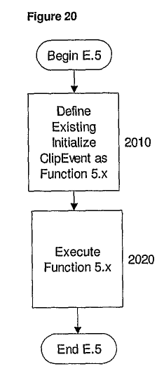

FIG. 10 is a flowchart representing the behaviour of code A when executed by a playback device. As code A was appended to the introduced segments in Movie 1mod, its execution implies the previous execution of the introduced segments. It is also assumed that code block B has been previously executed as references are made by A to structures created by B. The process begins at 1005 where a value (or ‘flag’) is set to designate to other code blocks that Movie 1mod has successfully executed before proceeding to 1010. At 1010, Function 1, which is created during the execution of code block B.2 and contains the frame script from the first frame of the main movie, is executed. Proceeding to 1015, a loop begins that checks Array 1 (created by B.1 or B.2) to determine if remaining references exist to instances of sub-movies created by the playback of E.2 or E.3. If no sub-movie references remain, the process continues to 1020. If at 1015 a reference to an instance is present, the process continues to 1090. At 1090 the playback device is instructed to return to and play the first frame of the referenced sub-movie instance before proceeding to 1093. At 1093, the Function 5.x that encapsulates initialization code specific to the instance of the sub-movie (created by code E.5, see FIG. 20) is executed. The process then returns to the beginning of the loop at 1015 and checks for a new reference.

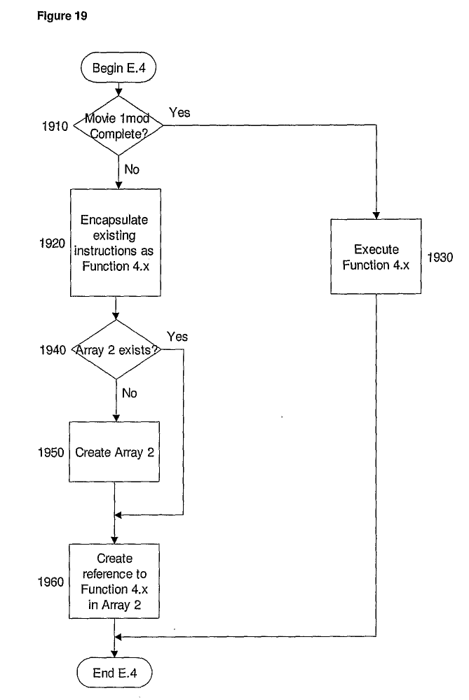

At 1020 the process begins a new loop that re-executes the Function 4.x created by the execution of E.4 (See FIG. 19). If no references are available in Array 2 (created in E.4), the process proceeds to 1025. If a reference is available, the Function 4.x corresponding to the reference is executed at 1050 and the process returns to the beginning of the loop at 1020.

At 1025, the loop that searches for references in Array 1 is re-initialized. Following 1025, the loop begins at 1030, checking for the next available reference. If no reference is available, Array 1 and Array 2 (if it exists) are removed at 1035. Subsequently, Movie 1mod is removed from the memory of the playback device at 1040 and the process ends.

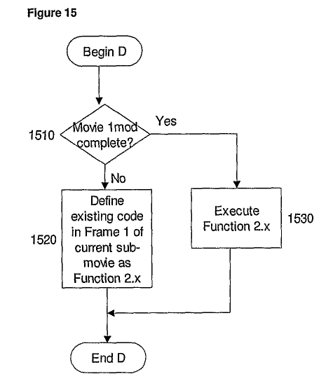

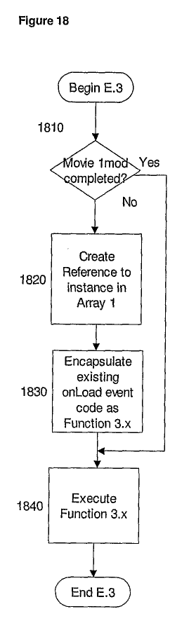

If at 1030 a reference is available, the playback device returns to and plays the first frame of the referenced sub-movie instance at 1060. Subsequently, the functions 2.x created on execution of D (See FIG. 15) and/or 3.x created on execution of E.3 (See FIG. 18) that are associated with the instance of the sub-movie are executed at 1075. The process then loops back to 1030.

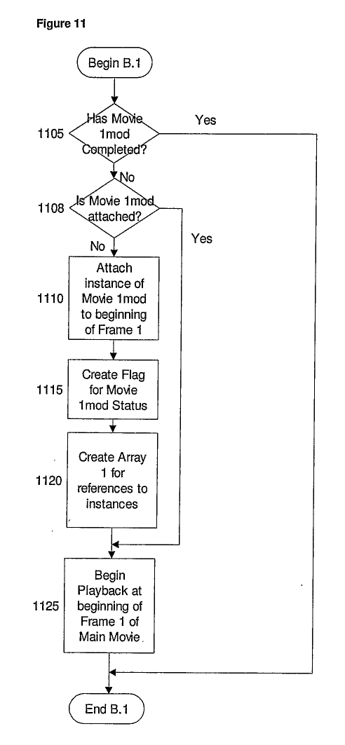

FIG. 11 is a flowchart that describes the behaviour of code block B.1 when executed by a playback device. The process begins at 1105 where it is determined whether Movie 1mod has previously executed. If the Movie 1mod has executed, the process immediately ends. If Movie 1mod has not executed, a determination is made at 1108 whether an instance of Movie 1mod has been attached to the first frame of the main timeline. If the instance is not attached, the process continues to 1110. If the instance is attached, the process continues to 1125. At 1110 an instance of Movie 1mod is attached to the beginning of frame 1 in the main movie. From 1110 the process continues to 1115 where a variable designating the status (or ‘flag’) of Movie 1mod is created. Following 1115, Array 1 is created at 1120. Array 1 is used to store references to instances of sub-movies that have instructions rewritten as functions. Following 1120, the playback device is instructed to return and play at the beginning of frame 1 of the main movie. The process then ends.

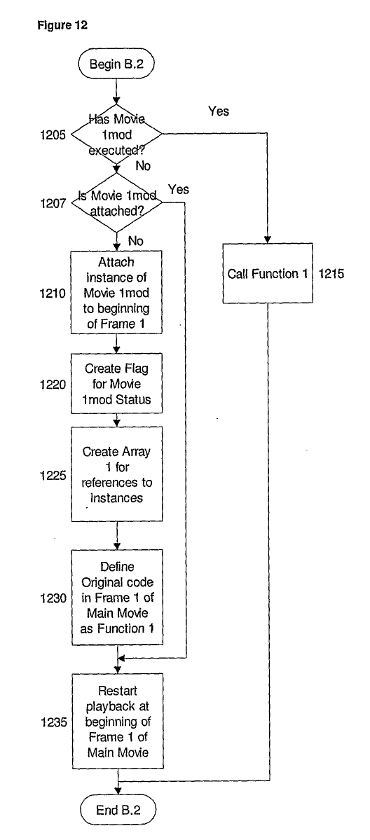

FIG. 12 is a flowchart that describes the behaviour of code block B.2 when executed by a playback device. The process begins at 1205 where it is determined whether Movie 1mod has previously executed. If Movie 1mod has not executed, a determination is made at 1207 whether an instance of Movie 1mod is already attached to frame 1 of the main timeline. If the instance has not been attached, the process continues to 1210. If the instance has been attached, the process continues to 1235. At 1210 an instance of Movie 1mod is attached to the beginning of frame 1 in the main movie. From 1210 the process continues to 1220 where a variable designating the status (or ‘flag’) of Movie 1mod is created. Following 1220, Array 1 is created at 1225. Array 1 is used to store references to instances of sub-movies that have instructions rewritten as functions. Following 1225, at 1230 any existing framescript located in the first frame of the main movie is redefined as a function and named Function 1. Subsequently at 1235, the playback device is instructed to return and play at the beginning of frame 1 of the main movie. The process then ends. If at 1205 Movie 1mod has executed, Function 1 is executed at 1215, and the process ends.

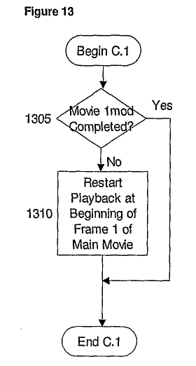

FIG. 13 is a flowchart that describes the behaviour of code block C.1 when executed by a playback device. The process begins at 1305 where it is determined whether Movie 1mod has previously executed. If Movie 1mod has executed the process ends. If Movie 1mod has not executed, the playback device is instructed at 1310 to return and play at the beginning of frame 1 of the main movie and the process then ends.

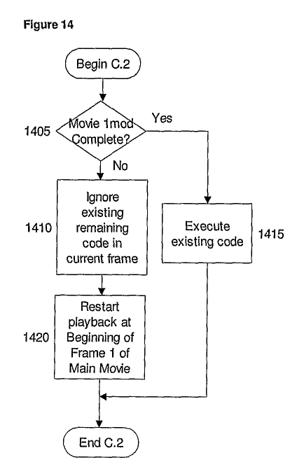

FIG. 14 is a flowchart that describes the behaviour of code block C.2 when executed by a playback device. The process begins at 1405 where it is determined whether Movie 1mod has previously executed. If Movie 1mod has executed the process continues to 1415 where existing code is executed before the process ends. If Movie 1mod has not executed, the playback device is instructed at 1410 to skip existing remaining code blocks. Subsequently, at 1420 the playback device is instructed to return and play at the beginning of frame 1 of the main movie. The process then ends.

FIG. 15 is a flowchart that describes the behaviour of code block D when executed by a playback device. The process begins at 1510 where it is determined whether Movie 1mod has previously executed. If Movie 1mod has not executed, the existing code within the first frame of the sub-movie is defined as a function at 1520 and named Function 2.x, where x is unique identifier for the sub-movie function. The process then ends. If at 1510 Movie 1mod is determined to be complete, Function 2.x is executed. The process then ends.

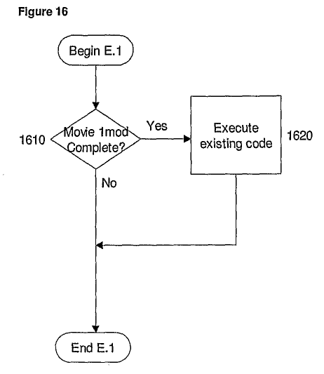

FIG. 16 is a flowchart that describes the behaviour of code block E.1 when executed by a playback device. The process begins at 1610 where a determination is made whether Movie 1mod has previously executed. If Movie 1mod has not executed, no existing instructions within the code block are executed and the process ends. If at Movie 1mod is determined to be complete, the existing instructions within the code block are executed. The process then ends.

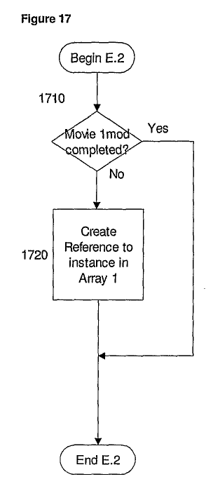

FIG. 17 is a flowchart that describes the behaviour of code block E.2 when executed by a playback device. The process begins at 1710 where a determination is made whether Movie 1mod has previously executed. If Movie 1mod has not executed, the process continues to 1720 where a reference is created to the instance of the sub-movie in Array 1. Following 1720, the process then ends. If at 1710 Movie 1mod is determined to be complete, the process then ends.

FIG. 18 is a flowchart that describes the behaviour of code block E.3 when executed by a playback device. The process begins at 1810 where a determination is made whether Movie 1mod has previously executed. If Movie 1mod has not executed, the process continues to 1820 where a reference is created to the instance of the sub-movie in Array 1. Following 1820, at 1830 existing instructions within the code block pertaining to an on Load event are defined as a function and named Function 3.x, where x is a unique identifier for the sub-movie function. The process continue to 1840 where Function 3.x is executed. If at 1810 Movie 1mod is determined to be complete, the process proceeds to 1840. Following 1840, the process then ends.

FIG. 19 is a flowchart that describes the behaviour of code block E.4 when executed by a playback device. The process begins at 1910 where a determination is made whether Movie 1mod has previously executed. If Movie 1mod has not executed, the process continues to 1920 where existing instructions within the code block pertaining to the initialization of the instance are defined as a function and named Function 4.x, where x is a unique identifier for the sub-movie function. The process then proceeds to 1940 where a determination is made as to whether Array 2 already exists. If Array 2 does not exist, the array is created at 1950 and continues to 1960. If the Array 2 already exists, the process continues directly to 1960. At 1960 a reference is created in Array 2 to Function 4.x. The process then ends. If at 1910 Movie 1mod is determined to be complete, Function 4.x is executed at 1930. The process then ends.

FIG. 20 is a flowchart illustrating the playback behaviour of code E.5. The process begins at 2010 once an initialization instruction is identified in reference to a specific instance of a sub-movie. The initialization code is encapsulated at 2010 and named Function 5.x, where x represents a unique identifier for the instance. Following 2010, at 2020 the same function, namely Function 5.x, is immediately executed and the process ends.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-49. (canceled)

50. A method for integrating at least one segment of a first multimedia work into a second multimedia work to produce a combined multimedia work, the method comprising:
inserting the at least one segment of the first multimedia work into the second multimedia work before an initial segment of the second multimedia work; and
updating instructions in the combined multimedia work in order to maintain the function of the instructions wherein updating instructions comprises determining whether instructions exist that execute on the initial frame of the second multimedia work, and if so, amending such instructions in the combined multimedia work to delay execution of at least one segment of the second multimedia work until after completion of execution of the at least one segment of the first multimedia work.

51. The method of claim 50 wherein instructions are inserted into the combined multimedia work to execute with the first multimedia work and to track presentation of the first multimedia work and cause presentation of the second multimedia work following completion of the first multimedia work.

52. The method of claim 50 comprising creating or amending a data file of the first multimedia work such that it may be displayed as a sub-movie in the second multimedia file when processed by a playback device.

53. The method of claim 50 wherein updating instructions in the combined multimedia work provides the ability to re-execute instructions whose execution has been delayed to allow the successful playback of the sub-movie representing the first multimedia work.

54. The method of claim 50, wherein updating of instructions in the combined multimedia work comprises inserting into the first frame of the main timeline instructions for creating a referencing system for those instructions specifically delayed from executing, should no framescript exist in an initial frame of the second multimedia work.

55. The method of claim 50, wherein updating of instructions in the combined multimedia work comprises inserting into the first frame of the main timeline instructions for creating a referencing system for those instructions specifically delayed from executing and for delaying existing framescript, should framescript exist in the initial frame of the second multimedia work.

56. The method of claim 50, wherein updating of instructions in the combined multimedia work comprises inserting into a second frame of a main timeline or a second frame of a sub-movie instructions for returning a playback device to a first frame of a main movie should the playback of the sub-movie representing the first multimedia work be incomplete, should there be no existing framescript.

57. The method of claim 50, wherein updating of instructions in the combined multimedia work comprises inserting into a second frame of a main timeline or a second frame of a sub-movie instructions for returning a playback device to a first frame of a main movie should the playback of the sub-movie representing the first multimedia work be incomplete, and for ignoring remaining existing framescript in that frame.

58. The method of claim 50, wherein updating of instructions in the combined multimedia work comprises inserting into a first frame of a sub-movie, appearing in the first frame of a main timeline of the second multimedia work, instructions for delaying the execution of existing framescript until the sub-movie representing the first multimedia work is complete.

59. The method of claim 50, wherein updating of instructions in the combined multimedia work comprises inserting instructions for delaying execution of an event-based, instance-specific instruction into the frame where the instance-specific instruction exists, the inserted instructions adopted to delay execution of the instance-specific instruction until completion of playback of the first multimedia work.

60. The method of claim 50 wherein updating instructions in the combined multimedia work comprises inserting into the first or second frame of a main timeline, or the first or second frame of an existing sub-movie timeline that is displayed in the first or second frame of the main timeline, instructions that pertain to the event of displaying a specific instance of a sub-movie and to facilitating a means for executing those instructions, should the playback of the sub-movie representing the first multimedia work not be complete, and should no instructions exist that relate to the presentation of that specific instance.

61. The method of claim 50 wherein updating instructions in the combined multimedia work comprises inserting into the first or second frame of a main timeline, or the first or second frame of an existing sub-movie timeline that is displayed in the first or second frame of the main timeline, instructions for delaying execution of existing instructions that pertain to the event of displaying a specific instance of a sub-movie, and for facilitating a means for re-executing those delayed instructions, should the playback of the sub-movie representing the first multimedia work be complete or otherwise.

62. The method of claim 50 wherein updating of instructions in the combined multimedia work comprises inserting into the first or second frame of a main timeline, or the first or second frame of an existing sub-movie timeline that is displayed in the first or second frame of the main timeline, instructions for delaying execution of existing instructions that define aspects of instances of a sub-movie before an instance of the sub-movie is first created, for creating a referencing system for such delayed instructions, for creating a reference to the delayed instructions should the playback of the sub-movie that represents the first multimedia work not be complete, and for executing the delayed instructions should the playback of the sub-movie representing the first multimedia work be complete.

63. The method of claim 50 wherein updating instructions in the combined multimedia work comprises inserting into the first or second frame of a main timeline, or the first or second frame of an existing sub-movie timeline that is displayed in the first or second frame of the main timeline, instructions that provide for existing instructions that define the properties and/or attributes of an instance of a sub-movie at the time of its creation to be referenced and executed as required.

64. The method of claim 50 further comprising integrating output files that contain the data needed to present the first and second multimedia works using a playback device, and producing an output file containing the data needed to present the combined multimedia work using a playback device.

65. A system for integrating at least one segment of a first multimedia work into a second multimedia work to produce a combined multimedia work, the system comprising:
means for inserting the at least one segment of the first multimedia work into the second multimedia work before an initial segment of the second multimedia work; and
means for updating instructions in the combined multimedia work in order to maintain the function of the instructions, wherein the updating instructions comprises determining whether instructions exist that execute on the initial frame of the second multimedia work, and if so, amending such instructions in the combined multimedia work to delay execution of at least one segment of the second multimedia work until after completion of execution of the at least one segment of the first multimedia work.

66. A system for integrating at least one segment of a first multimedia work into a second multimedia work to produce a combined multimedia work, the system comprising:
means for inserting the at least one segment of the first multimedia work into the second multimedia work before an initial segment of the second multimedia work; and
means for updating instructions in the combined multimedia work in order to maintain the function of the instructions, wherein the updating instructions comprises determining whether instructions exist that execute on the initial frame of the second multimedia work, and if so, amending such instructions in the combined multimedia work to delay execution of at least one segment of the second multimedia work until after completion of execution of the at least one segment of the first multimedia work;
wherein the means for updating instructions is adapted to perform the method of claim 53.

67. A method for integrating a first multimedia work and a second multimedia work to produce a combined multimedia work, the method comprising:
converting the first multimedia work into a sub-movie format;
inserting the converted first multimedia work into the second multimedia work before an initial segment of the second multimedia work as a sub-movie of the second multimedia work to produce a combined multimedia work; and
updating instructions in the combined multimedia work in order to maintain the function of the instructions, wherein updating the instructions comprises determining whether instructions exist that execute on the initial frame of the second multimedia work, and if so, amending such instructions in the combined multimedia work to delay execution of at least one segment of the second multimedia work until after completion of execution of the at least one segment of the first multimedia work.
